(19) United States
(12) Patent Application Publication
(10) Pub. No.: US 2006/0170637 A1
(43) Pub. Date: Aug. 3, 2006

(54) LCD panel and LCD device

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/339,581

(22) Filed: Jan. 26, 2006

(30) Foreign Application Priority Data
Feb. 2, 2005 (TW) 094103281

(51) Int. Cl. G09G 3/36

(52) U.S. Cl. 345/96

(57) ABSTRACT

An LCD (liquid crystal display) panel is electrically connected to a control circuit board, which at least outputs a common voltage. The LCD panel includes a transistor substrate having at least one metal trace, a color filter plate having a common electrode layer and facing to the transistor substrate, a liquid crystal layer disposed between the transistor substrate and color filter plate, and at least one image data driving integrated circuit. The image data driving integrated circuit is disposed on the transistor substrate, and includes a common voltage buffer circuit. The common voltage passes through the metal trace and is then inputted into the common voltage buffer circuit. After processed by the common voltage buffer circuit, the common voltage is outputted into the common electrode layer.

### BACKGROUND OF THE INVENTION

1. Field of Invention

The invention relates to an LCD (liquid crystal display) panel and an LCD device, and in particular, to an LCD panel and an LCD device, which have an image data driving IC (integrated circuit) directly bonded on a glass substrate.

2. Related Art

The conventional LCD device mainly includes an LCD panel and a backlight module.

As shown in FIG. 1, the conventional LCD panel mainly includes a transistor substrate 11, a color filter plate 12 and a liquid crystal layer 13. In this case, the liquid crystal layer 13 is encapsulated in between the transistor substrate 11 and the color filter plate 12 with a molding compound 14.

The direction of the liquid crystal in the liquid crystal layer 13 is controlled based on the electrode of the transistor on the transistor substrate 11 and an opposite electrode layer 121 (a common electrode layer) formed on the color filter plate 12. The light emitted from the backlight module (as the arrow shown in FIG. 1) passes the liquid crystal layer 13 according to the direction of the liquid crystal, and the color of the light is then mixed by the color filter plate 12. Finally, the light is irradiated out of the color filter plate 12.

As shown in FIG. 2, the common voltage V_{com} of the conventional opposite electrode layer 121 is outputted from a control circuit board 15. Then, the common voltage V_{com} is inputted into a flexible circuit board 18 of an image data driving IC 19 through a connecting element 17 of a connecting circuit board 16 (so-called X-board). Through the flexible circuit board 18 and the transistor substrate 11, the common voltage V_{com} is finally inputted t the opposite electrode layer 121. In the above-mentioned circuit architecture, the voltage or signal outputted from the control circuit board 15 must pass through the connecting circuit board 16 and the flexible circuit board 18 for achieving the transistor substrate 11 and the opposite electrode layer 121, so that not only the cost but the reliability is the considerable issues. In addition, since the common voltage V_{com} passes through the connecting element 17, the connecting circuit board 16, the flexible circuit board 18 and the trace of the transistor substrate 11, many resistances of variant values are correspondingly generated in this traveling route. In other words, the value of the common voltage V_{com} outputted from the control circuit board 15 may be affected by the resistance of the traveling route. Thus, the values of the common voltage inputted into corresponding points of the opposite electrode layer 121 are different, which may result in the alternate cross talk issue.

Recently, the manufacturer has disclosed a design to directly dispose the image data driving IC at one side of the transistor substrate 11, so that the connecting circuit board 16 and the flexible circuit board 18 are unnecessary. Thus, the manufacturing cost can be reduced. FIG. 3 shows an example of directly disposing the image data driving IC 19 at one side of the transistor substrate 11. As shown in FIG. 3, the common voltage V_{com} outputted from the control circuit board 15 directly passes through the metal trace 111 of the transistor substrate 11 to the opposite electrode layer 121. Although this circuit architecture can reduce the manufacturing cost, the alternate cross talk issue cannot be improved efficiently. That is because the value of the common voltage V_{com} is still affected by the resistance of the metal trace 111 of the transistor substrate 11.

To eliminate the effect on the common voltage V_{com} caused by the resistance of the metal trace, some manufacturers disclosed a design to dispose an internal trace 191 in the image data driving IC 19. As shown in FIG. 4, the metal traces 112 of the transistor substrate 11 are respectively electrically connected to the internal traces 191 of the image data driving ICs 19. Although this circuit architecture can improve the effect on the common voltage V_{com} caused by the resistance of the metal trace, the alternate cross talk issue still exists.

As mentioned above, it is an important subject of the invention to provide an LCD panel and an LCD device having the stable common voltage.

### SUMMARY OF THE INVENTION

In view of the foregoing, the invention is to provide an LCD (liquid crystal display) panel that has a stable common voltage.

In view of the foregoing, the invention is also to provide an LCD (liquid crystal display) device that has a stable common voltage.

To achieve the above, an LCD panel of the invention is electrically connected to a control circuit board, which at least outputs a common voltage. The LCD panel includes a transistor substrate, a color filter plate, a liquid crystal layer, and at least one image data driving IC (integrated circuit). In the invention, the transistor substrate has at least one metal trace, and the color filter plate has a common electrode layer and faces to the transistor substrate. The liquid crystal layer is disposed between the transistor substrate and the color filter plate. The image data driving IC is disposed on the transistor substrate and has a common voltage buffer circuit. The common voltage passes through the metal trace and is then inputted into the common voltage buffer circuit. The common voltage buffer circuit processes the common voltage, and then the processed common voltage is outputted into the common electrode layer.

To achieve the above, the invention discloses another LCD panel, which is electrically connected to a control circuit board at least outputting a common voltage. The LCD panel includes a transistor substrate, a color filter plate, a liquid crystal layer, and at least one common voltage buffer circuit. In the invention, the transistor substrate has at least one metal trace, and the color filter plate has a common electrode layer and faces to the transistor substrate. The liquid crystal layer is disposed between the transistor substrate and the color filter plate. The common voltage buffer circuit is disposed on the transistor substrate. The common voltage passes through the metal trace and is then inputted into the common voltage buffer circuit. Then, the common voltage buffer circuit processes the common voltage, and the processed common voltage is outputted into the common electrode layer.

As mentioned above, the LCD panel of the invention has the common voltage buffer circuit. Therefore, the common voltage outputted from the control circuit board can be processed by the common voltage buffer circuit and thus has smaller current value while traveling through the metal trace. In other words, due to the action of the common voltage buffer circuit, the common voltage may not induce a large voltage drop in the metal trace. Accordingly, the value of the common voltage outputted into the common electrode layer can be kept in stable.

To achieve the above, the invention also discloses an LCD (liquid crystal display) device, which includes an LCD panel and a backlight module. The LCD panel is electrically connected to a control circuit board, which at least outputs a common voltage. In the invention, the LCD panel includes a transistor substrate, a color filter plate, a liquid crystal layer, and at least one common voltage buffer circuit. The transistor substrate has at least one metal trace, and the color filter plate has a common electrode layer and faces to the transistor substrate. The liquid crystal layer is disposed between the transistor substrate and the color filter plate. The common voltage buffer circuit is disposed on the transistor substrate. The common voltage passes through the metal trace and is then inputted into the common voltage buffer circuit. Then, the common voltage buffer circuit processes the common voltage, and the processed common voltage is outputted into the common electrode layer.

As mentioned above, the LCD device of the invention has the common voltage buffer circuit. Therefore, the common voltage outputted from the control circuit board can be processed by the common voltage buffer circuit and thus has smaller current value while traveling through the metal trace. In other words, due to the action of the common voltage buffer circuit, the common voltage may not induce a large voltage drop in the metal trace. Accordingly, the value of the common voltage outputted into the common electrode layer can be kept in stable.

### BRIEF DESCRIPTION OF THE DRAWINGS

The invention will become more fully understood from the detailed description given herein below illustration only, and thus is not limitative of the present invention, and wherein:

FIG. 1 is a schematic sectional illustration of the conventional LCD panel;

FIG. 2 is a schematic illustration showing the architecture of the connection of the conventional LCD panel and the control circuit board;

FIG. 3 is a schematic illustration showing the additional architecture of the connection of the conventional LCD panel and the control circuit board;

FIG. 4 is a schematic illustration showing yet additional architecture of the connection of the conventional LCD panel and the control circuit board;

FIG. 5 is a schematic illustration showing architecture of the connection of a control circuit board and an LCD panel according to a preferred embodiment of the invention;

FIG. 6 is a schematic diagram showing a common voltage buffer circuit of the LCD panel according to the embodiment of the invention;

FIG. 7 is a block diagram showing an image data driving IC of the LCD panel according to the embodiment of the invention; and

FIG. 8 is a schematic illustration showing architecture of the connection of a control circuit board and an LCD panel according to another preferred embodiment of the invention.

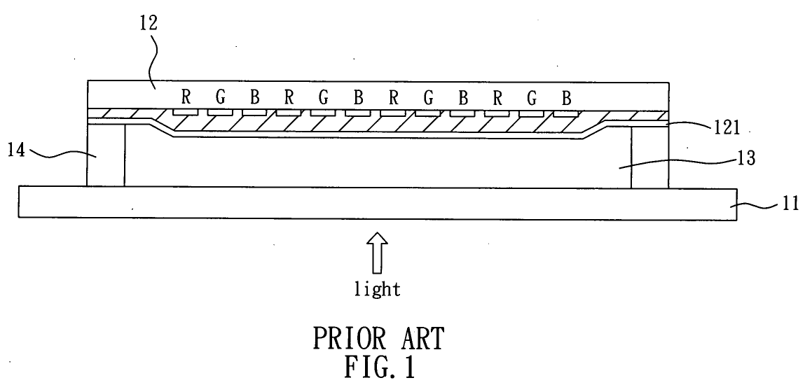

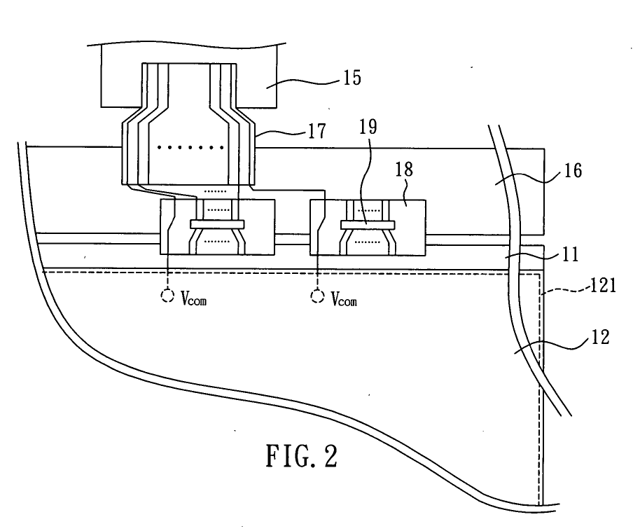

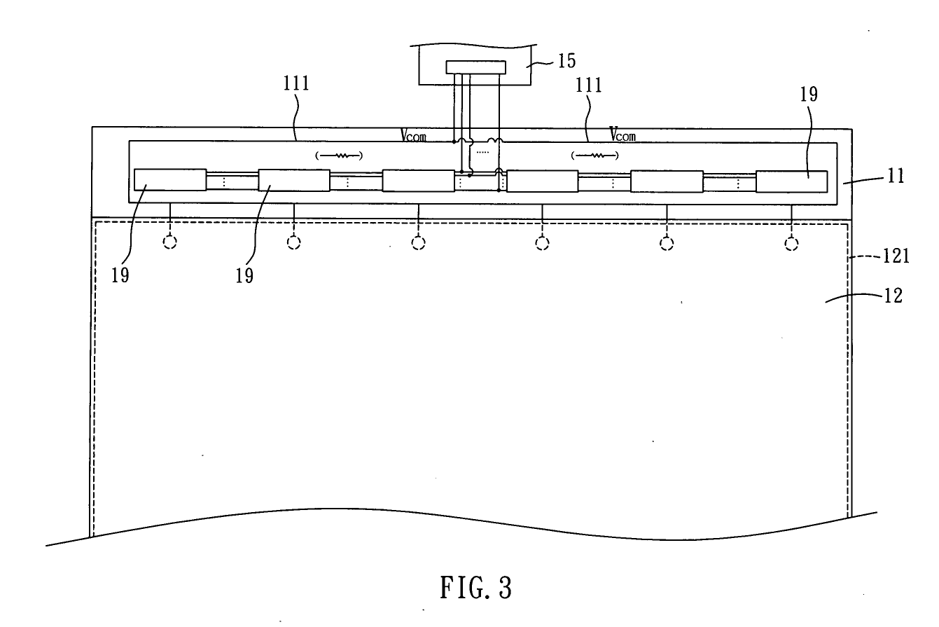

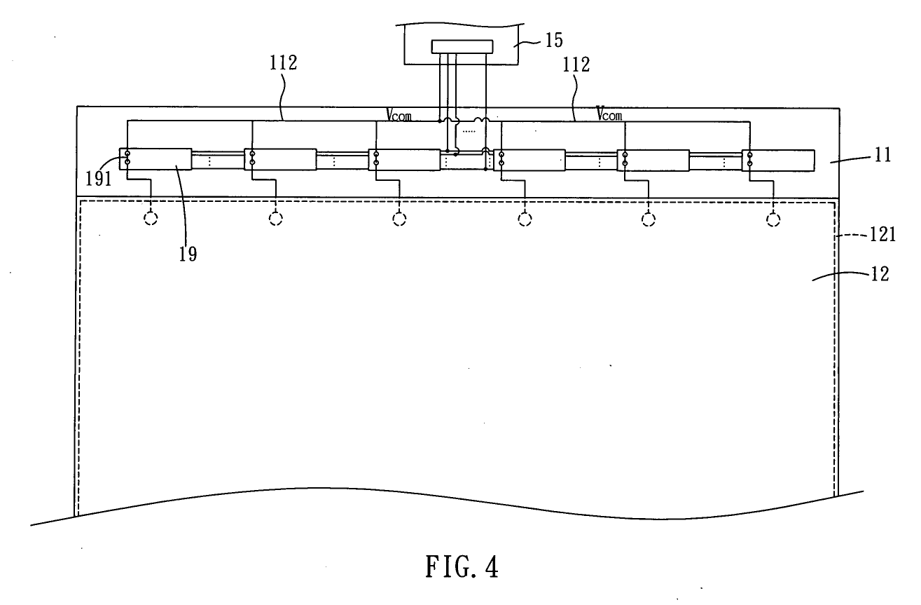

### DETAILED DESCRIPTION OF THE INVENTION

The present invention will be apparent from the following detailed description, which proceeds with reference to the accompanying drawings, wherein the same references relate to the same elements.

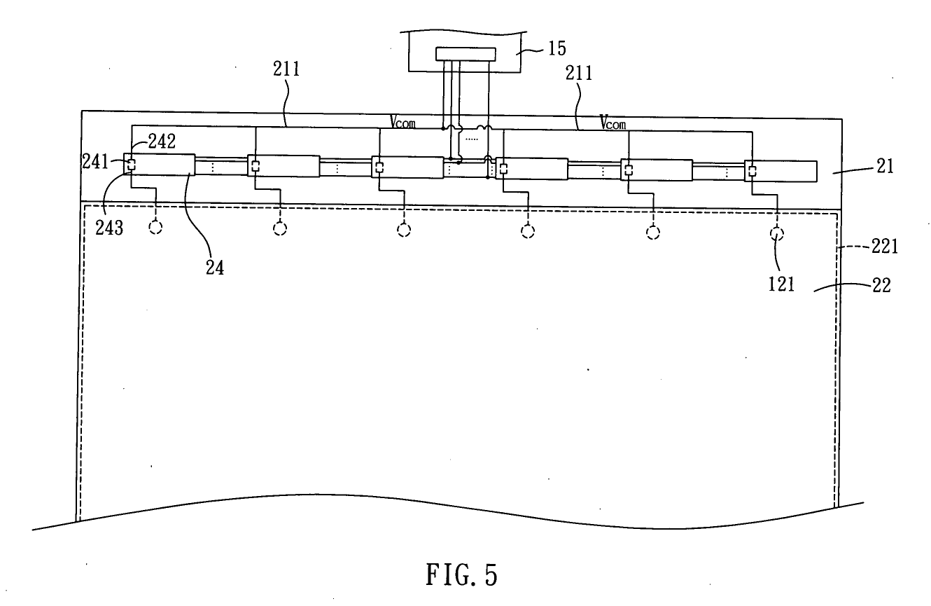

With reference to FIG. 5, an LCD panel according to a preferred embodiment of the invention is electrically connected to a control circuit board 15, which at least outputs a common voltage V_{com}. The LCD panel includes a transistor substrate 21, a color filter plate 22, a liquid crystal layer (not shown), and at least one image data driving IC (integrated circuit) 24.

As shown in FIG. 5, the transistor substrate 21 has several metal trace 211. In this embodiment, the transistor substrate 21 may be a TFT (thin-film transistor) glass substrate. The color filter plate 22 has a common electrode layer 221, such as an ITO electrode layer, and is disposed facing to the transistor substrate 21. The liquid crystal layer is disposed between the transistor substrate 21 and the color filter plate 32.

The image data driving IC 24 is disposed on the transistor substrate 21. In practice, the image data driving IC 24 can be formed on the transistor substrate 21 with the COG (chip on glass) technology. The image data driving IC 24 has a common voltage buffer circuit 241. The common voltage V_{com} passes through the metal trace 211 and is then inputted into the common voltage buffer circuit 241. The common voltage buffer circuit 241 processes the common voltage V_{com}, and the processed common voltage V_{com} is then outputted into the common electrode layer 221. In the current embodiment, the image data driving IC 24 may be a chip package, which is disposed on the transistor substrate 21 by a flip-chip technology.

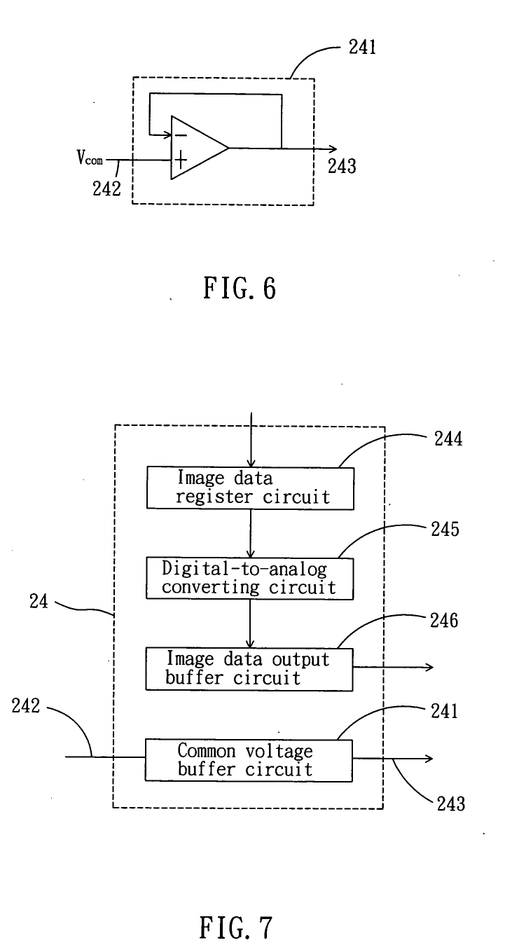

With reference to FIG. 6, the common voltage buffer circuit 241 of the image data driving IC 24 may be a negative feedback operational amplifier. The common voltage buffer circuit 241 has an input terminal 242 and an output terminal 243. The input terminal 242 is electrically connected to the metal trace 211 and the output terminal 243 is electrically connected to the common electrode layer 221. The common voltage V_{com} is inputted into the common voltage buffer circuit 241 through the input terminal 242 and is then outputted into the common electrode layer 221 through the output terminal 243.

With reference to FIG. 7, the image data driving IC 24 of the embodiment further includes an image data register circuit 244, a digital-to-analog converting circuit 245, and an image data output buffer circuit 246. In the present embodiment, the image data register circuit 244 receives a digital image data outputted from the control circuit board 15. The digital-to-analog converting circuit 245 converts the digital image data outputted from the control circuit board 15 into an analog image data The image data output buffer circuit 246 outputs the analog image data.

As mentioned above, the image data driving IC 24 of the LCD panel of the invention has a common voltage buffer circuit 241. Therefore, the common voltage V_{com} outputted from the control circuit board 15 can be processed by the common voltage buffer circuit 241 and thus has smaller current value while traveling through the metal trace 211. In other words, due to the action of the common voltage buffer circuit 241, the common voltage V_{com} may not induce a large voltage drop in the metal trace 211. Accordingly, the value of the common voltage V_{com} outputted into the common electrode layer 221 can be kept in stable. As a result, the LCD panel of the invention can avoid the alternate cross talk issue.

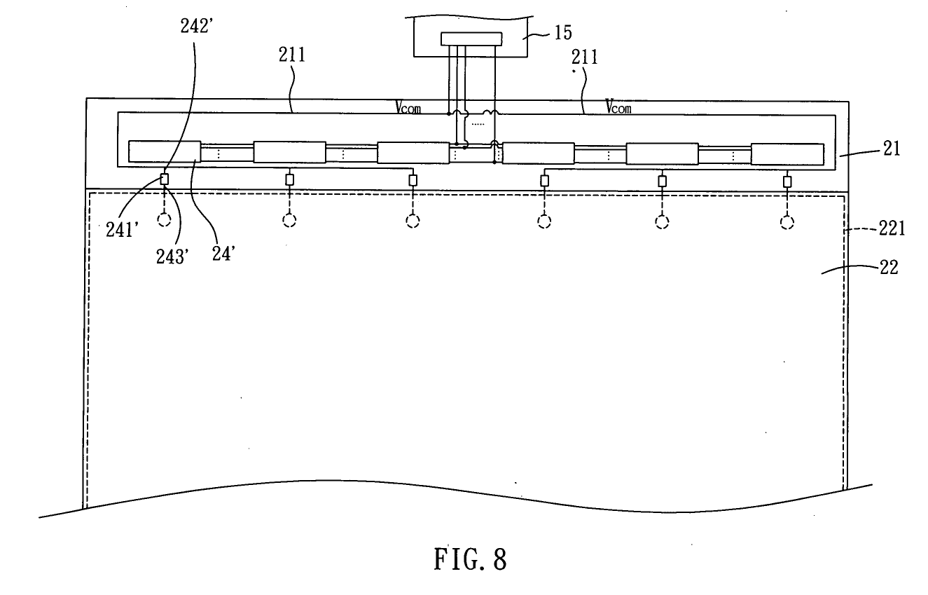

FIG. 8 is a schematic illustration showing an LCD panel according to another preferred embodiment of the invention. As shown in FIG. 8, the LCD panel is electrically connected to a control circuit board 15, which at least outputs a common voltage V_{com}. The LCD panel includes a transistor substrate 21, a color filter plate 22, a liquid crystal layer (not shown), at least image data driving IC 24′, and at least one common voltage buffer circuit 241′. In the embodiment, the common voltage V_{com} outputted from the control circuit board 15 is inputted into an input terminal 242′ of each common voltage buffer circuit 241′ through the metal traces 211. The common voltage buffer circuit 241′ processes the common voltage V_{com}, and the processed common voltage V_{com} is then outputted into the common electrode layer 221 through the output terminal 243′.

In the present embodiment, each common voltage buffer circuit 241′ may be a single-chip integrated circuit (IC) or may be composed of at least one thin-film transistor (TFT). Of course, each common voltage buffer circuit 241′ may be a negative feedback operational amplifier, and it may be formed on the transistor substrate 21 directly.

As mentioned above, the LCD panel of the invention has a common voltage buffer circuit 241′. Therefore, the common voltage V_{com} outputted from the control circuit board 15 can be processed by the common voltage buffer circuit 241′ and thus has smaller current value while traveling through the metal trace 211. In other words, due to the action of the common voltage buffer circuit 241′, the common voltage V_{com} may not induce a large voltage drop in the metal trace 211. Accordingly, the value of the common voltage V_{com} outputted into the common electrode layer 221 can be kept in stable. As a result, the LCD panel of the invention can avoid the alternate cross talk issue.

To make the invention more comprehensive, an LCD device according to a preferred embodiment of the invention will be describe hereinafter, wherein the same references of the following embodiment relate to the same elements and references in the previous embodiment.

The LCD device according to the embodiment of the invention includes an LCD panel and a backlight module.

With reference to FIG. 5 again, the LCD panel is electrically connected to a control circuit board 15, which at least outputs a common voltage. The LCD panel includes a transistor substrate 21, a color filter plate 22, a liquid crystal layer (not shown), and at least one image data driving IC (integrated circuit) 24. Since the descriptions of the LCD panel of the LCD device in this embodiment are the same as those of the previous embodiment, the detailed descriptions are omitted herein for concise purpose.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An LCD (liquid crystal display) panel, which is electrically connected to a control circuit board at least outputting a common voltage, comprising:
a transistor substrate having at least one metal trace;
a color filter plate having a common electrode layer and facing to the transistor substrate;
a liquid crystal layer disposed between the transistor substrate and the color filter plate; and
at least an image data driving integrated circuit disposed on the transistor substrate and having a common voltage buffer circuit, wherein the common voltage passes through the metal trace and is then inputted into the common voltage buffer circuit, the common voltage buffer circuit processes the common voltage, and then the processed common voltage is outputted into the common electrode layer.

2. The LCD panel of claim 1, wherein the common voltage buffer circuit has an input terminal electrically connected to the metal trace and an output terminal electrically connected to the common electrode layer, and the common voltage is inputted into the common voltage buffer circuit through the input terminal and is then outputted into the common electrode layer through the output terminal.

3. The LCD panel of claim 1, wherein the transistor substrate is a TFT (thin-film transistor) glass substrate.

4. The LCD panel of claim 1, wherein the image data driving integrated circuit further comprises an image data register circuit for receiving a digital image data outputted from the control circuit board, a digital-to-analog converting circuit for converting the digital image data outputted from the control circuit board into an analog image data, and an image data output buffer circuit for outputting the analog image data.

5. The LCD panel of claim 1, wherein the common voltage buffer circuit is an operational amplifier.

6. The LCD panel of claim 5, wherein the operational amplifier is a negative feedback operational amplifier.

7. The LCD panel of claim 1, wherein the image data driving integrated circuit is disposed on the transistor substrate by a flip-chip technology.

8. The LCD panel of claim 1, wherein the image data driving integrated circuit is a chip package.

9. An LCD (liquid crystal display) panel, which is electrically connected to a control circuit board at least outputting a common voltage, comprising:
a transistor substrate having at least one metal trace;
a color filter plate having a common electrode layer and facing to the transistor substrate;
a liquid crystal layer disposed between the transistor substrate and the color filter plate; and
at least a common voltage buffer circuit disposed on the transistor substrate, wherein the common voltage passes through the metal trace and is then inputted into the common voltage buffer circuit, the common voltage buffer circuit processes the common voltage, and then the processed common voltage is outputted into the common electrode layer.

10. The LCD panel of claim 9, wherein the common voltage buffer circuit is an operational amplifier.

11. The LCD panel of claim 10, wherein the operational amplifier is a negative feedback operational amplifier.

12. The LCD panel of claim 9, wherein the common voltage buffer circuit is a single-chip integrated circuit.

13. The LCD panel of claim 9, wherein the common voltage buffer circuit is composed of at least one thin-film transistor (TFT).

14. An LCD (liquid crystal display) device, which comprises an LCD panel and a backlight module, wherein the LCD panel is electrically connected to a control circuit board and the control circuit board at least outputs a common voltage, the LCD panel comprising:
a transistor substrate having at least one metal trace;
a color filter plate having a common electrode layer and facing to the transistor substrate;
a liquid crystal layer disposed between the transistor substrate and the color filter plate; and
at least an image data driving integrated circuit disposed on the transistor substrate and having a common voltage buffer circuit, wherein the common voltage passes through the metal trace and is then inputted into the common voltage buffer circuit, the common voltage buffer circuit processes the common voltage, and then the processed common voltage is outputted into the common electrode layer.

15. The LCD device of claim 14, wherein the common voltage buffer circuit has an input terminal electrically connected to the metal trace and an output terminal electrically connected to the common electrode layer, and the common voltage is inputted into the common voltage buffer circuit through the input terminal and is then outputted into the common electrode layer through the output terminal.

16. The LCD device of claim 14, wherein the transistor substrate is a TFT (thin-film transistor) glass substrate.

17. The LCD device of claim 14, wherein the image data driving integrated circuit further comprises an image data register circuit for receiving a digital image data outputted from the control circuit board, a digital-to-analog converting circuit for converting the digital image data outputted from the control circuit board into an analog image data, and an image data output buffer circuit for outputting the analog image data.

18. The LCD device of claim 14, wherein the common voltage buffer circuit is an operational amplifier.

19. The LCD device of claim 18, wherein the operational amplifier is a negative feedback operational amplifier.

20. The LCD device of claim 14, wherein the image data driving integrated circuit is disposed on the transistor substrate by a flip-chip technology.

21. The LCD device of claim 14, wherein the image data driving integrated circuit is a chip package.
